(19) United States
(12) Patent Application Publication
(10) Pub. No.: US 2014/0246989 A1
(43) Pub. Date: Sep. 4, 2014

(54) CHARGE RECYCLING DEVICE AND PANEL DRIVING APPARATUS AND DRIVING METHOD USING THE SAME

(71) Applicant: NOVATEK Microelectronics Corp., Hsin-Chu (TW)

(72) Inventor: Tse-Hung Wu, New Taipei City (TW)

(73) Assignee: NOVATEK Microelectronics Corp., Hsin-Chu (TW)

(21) Appl. No.: 14/281,906

(22) Filed: May 20, 2014

Related U.S. Application Data
(62) Division of application No. 13/297,277, filed on Nov. 16, 2011.

(30) Foreign Application Priority Data
Jul. 21, 2011 (TW) 100125776

(51) Int. Cl. G09G 3/36

(52) U.S. Cl. CPC G09G 3/3655; G09G 2330/023
USPC 315/240

(57) ABSTRACT

A charge recycling device for a panel display apparatus is disclosed. The charge recycling device includes one or more storage capacitors, and one or more switch modules coupled to the one or more storage capacitors and coupled to a plurality of load capacitors via a plurality of source driving nodes, for controlling currents between the plurality of load capacitors and the one or more storage capacitors. During a charge recycling period, the one or more switch modules are arranged to recycle charges stored in the plurality of load capacitors to the one or more storage capacitors. During a charge reutilization period, the one or more switch modules are arranged to redistribute the recycled charges to the plurality of load capacitors.

### CROSS REFERENCE TO RELATED APPLICATIONS

This application is a divisional application of U.S. application Ser. No. 13/297,277, filed on Nov. 16, 2011, the contents of which are incorporated herein.

### BACKGROUND OF THE INVENTION

1. Field of the Invention

The present invention relates to a charge recycling device, panel driving apparatus and driving method, and more particularly, to a charge recycling device capable of reducing driving power consumption via recycling load charge, and related panel driving apparatus and driving method.

2. Description of the Prior Art

A liquid crystal display (LCD) display has characteristics of light weight, low power consumption, zero radiation, etc. and is widely used in many information technology (IT) products, such as computer systems, mobile phones, and personal digital assistants (PDAs). The operating principle of the LCD display is based on the fact that different twist states of liquid crystals result in different polarization and refraction effects on light passing through the liquid crystals. Thus, the liquid crystals can be used to control amount of light emitted from the LCD display by arranging the liquid crystals indifferent twist states, so as to produce light outputs at various brightnesses, and diverse gray levels of red, green and blue light.

Generally, a liquid crystal material needs to be driven with a voltage of a periodically alternating polarity (polarity inversion), to avoid permanently polarizing which damages the liquid crystal material, and the “image sticking” effect. Therefore, four different LCD driving methods have been proposed: frame inversion, line inversion, pixel inversion, and dot inversion. When frame inversion is employed, each frame has data signals of a same polarity, while a next frame has data signals of the opposite polarity. Line inversion maybe further divided into row inversion and column inversion. When using row inversion to drive an LCD device, data signals in each row have an opposite polarity to that in the neighboring row. When using column inversion, each column has data signals of an opposite polarity to that a neighboring column. When using pixel inversion, each pixel unit has a data signal of an opposite polarity to that of the neighboring pixel unit. Pixel and dot inversion driving methods provide higher display quality, and have therefore become the mainstream LCD driving method.

Please refer to FIG. 1, which is a schematic diagram of an LCD display 10 of the prior art . The LCD display 10 includes an LCD display panel 100, agate driver 110, a source driver 120, and a common driver 130. The LCD display panel 100 includes pixels arranged in a matrix, for display various colors. The common driver 130 provides a reference voltage Vcom to the LCD display panel 100. The gate driver 110 sequentially outputs gate driving signals VG1-VGN to the LCD display panel 100, to indicate update timing for each row of pixels. According to dot inversion, the source driving signals VS1-VSM outputted by the source driver 120 have an opposite polarity to that of a neighboring source driving signal. For example, the source driving signals VSX, VSX+1 have opposite polarities. Also, when scanning a different row, the source driving signals VSX, VSX+1 have to undergo polarity inversion according to the gate driving signals VG1-VGN. In other words, the source driver 120 needs to sequentially alternate between charging and discharging load capacitors corresponding to pixels on the X-th row and the (X+1)th row of the LCD display panel 100 to a positive polarity or negative polarity, respectively, which is extremely power-consuming and uneconomical.

To reduce driving power consumption, the LCD display 10 may utilize extra switch modules to couple load capacitors of adjacent pixels in the horizontal (row) direction between each row-pixel scan cycle, so as to alleviate the source driver 120 by canceling out the positive/negative polarity charges via charge sharing. However, the effects of this method are limited. Thus, how to implement a more power-efficient dot inversion driving method has become a common goal in the industry.

### SUMMARY OF THE INVENTION

Therefore, a primary objective of the disclosure is to provide a charge recycling device and related panel driving apparatus and driving method.

A charge recycling device for a panel display apparatus is disclosed. The charge recycling device comprises one or more storage capacitors; and one or more switch modules, coupled to the one or more storage capacitors, and coupled to a plurality of load capacitors via a plurality of source driving nodes, for controlling currents between the plurality of load capacitors and the one or more storage capacitors; wherein during a charge recycling period, the one or more switch modules are arranged to recycle charges stored in the plurality of load capacitors to the one or more storage capacitors; and during a charge reutilization period, the one or more switch modules are arranged to redistribute the recycled charges from the one or more storage capacitors to the plurality of load capacitors.

A driving method for driving a panel display apparatus is disclosed. The driving method comprises sequentially performing following steps: providing a plurality of source driving signals of a first polarity configuration status via a plurality of source driving nodes, to store charges into a plurality of load capacitors to which the plurality of source driving nodes are coupled; performing a charge recycling operation, for recycling the charges stored in the plurality of load capacitors to one or more storage capacitors; performing a charge reutilization operation, for redistributing the charges recycled by the one or more storage capacitors to the plurality of load capacitors; and providing the plurality of source driving signals of a second polarity configuration status via the plurality of source driving nodes.

Another charge recycling device for a panel display apparatus is disclosed. The charge recycling device comprises a storage capacitor; and a switch module, coupled to the storage capacitor and a first and second source driving node of a plurality of source driving nodes, wherein the switch module comprises: a first set of switches, comprising a first and second switch, coupled to two terminals of the storage capacitor, respectively, and to a reference voltage; and a second set of switches, comprising a third and fourth switch, coupled to the two terminals of the storage capacitor, respectively, and to the first source driving node, and a fifth and sixth switch, coupled to the two terminals of the storage capacitor, respectively, and to the second source driving node.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an LCD display of the prior art.

FIG. 2 is a schematic diagram of a panel driving apparatus according to an embodiment of the invention.

FIG. 3A is a schematic diagram of a detailed structure of a charge recycling device of the panel driving apparatus shown in FIG. 2 according to an embodiment.

FIGS. 3B-3G are timing diagrams of operations of the charge recycling device shown in FIG. 3A according to different embodiments.

FIG. 4A is a schematic diagram of a variation of the charge recycling device shown in FIG. 3A according to an embodiment.

FIGS. 4B-4E and FIGS. 5A-5D are timing diagrams of operations of the charge recycling device shown in FIG. 4A according to different embodiments.

FIG. 6 is a schematic diagram of a variation of the panel driving apparatus shown in FIG. 2 according to an embodiment.

FIG. 7A is a schematic diagram of a detailed structure of a charge recycling device of the panel driving apparatus shown in FIG. 6 according to an embodiment.

FIG. 7B is a schematic diagram of a variation of the charge recycling device shown in FIG. 7A according to an embodiment.

FIG. 8A is a timing diagram of operations of the charge recycling device shown in FIG. 7A according to an embodiment.

FIG. 8B is a timing diagram of operations of the charge recycling device shown in FIG. 7B according to an embodiment.

FIG. 9 is a schematic diagram of driving process according to an embodiment of the present invention.

### DETAILED DESCRIPTION

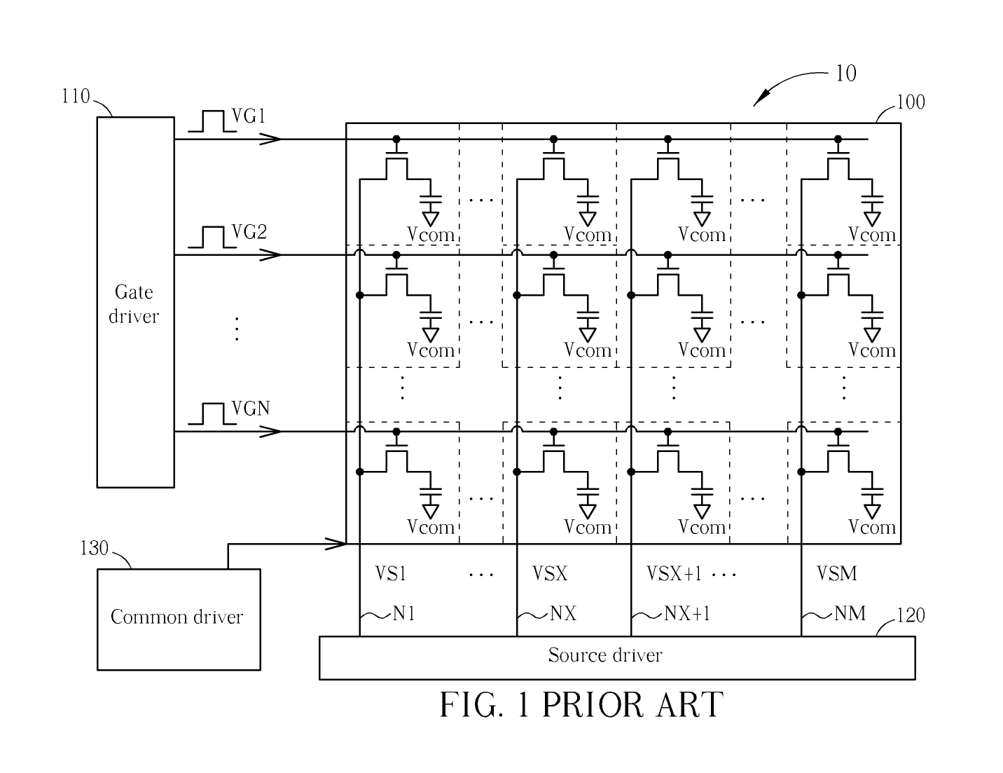

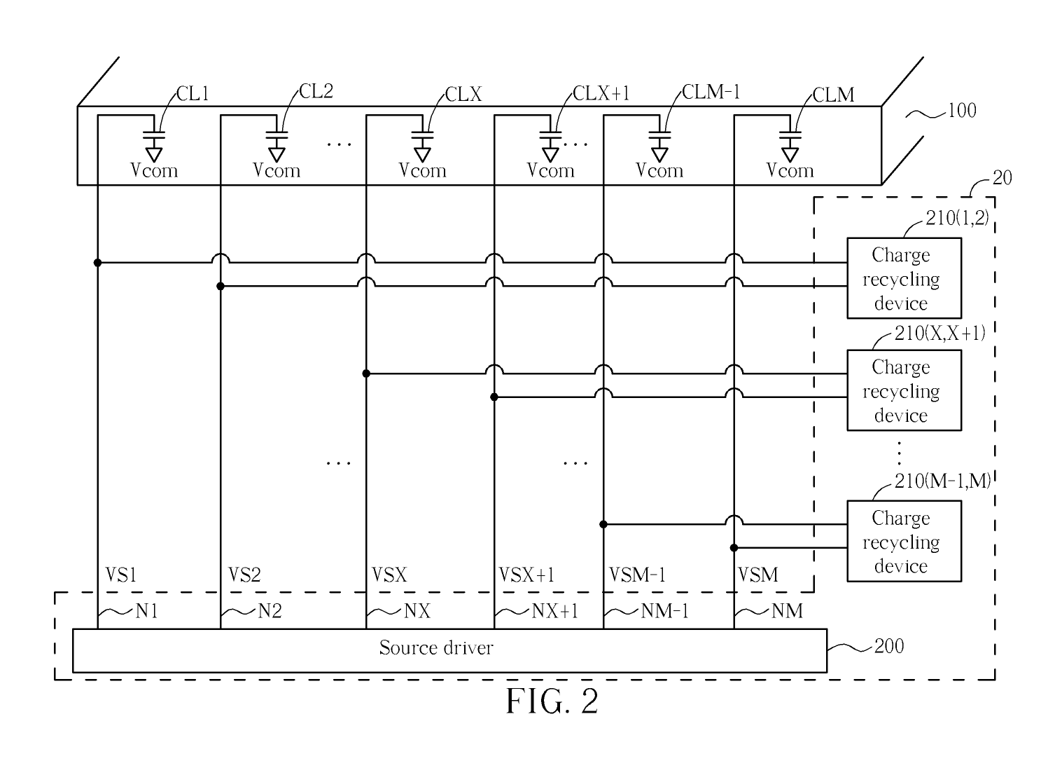

Please refer to FIG. 2, which is a schematic diagram of a panel driving apparatus 20 according to an embodiment of the invention. The panel driving apparatus 20 provides source driving signals VS1-VSM to a display panel, such as the LCD display panel 100 shown in FIG. 1. Note that, load capacitors CL1-CLM of the LCD display panel 100 can be equivalent capacitors between two ends of the panel of pixels being driven. The panel driving apparatus 20 includes a source driver 200 and charge recycling devices 210(1, 2)-210 (M−1, M). The source driver outputs the source driving signals VS1-VSM to the load capacitors CL1-CLM to update pixel content via source driving nodes N1-NM, respectively. Each of the charge recycling devices 210(1,2)-210(M−1, M), e.g. the charge recycling device 210(X, X+1), wherein X is an integer between 1 and M, can sequentially perform a charge recycling operation and a charge reutilization operation to conserve power consumption during a polarity transition period of the source driving signals VSX and VSX+1 outputted by the source driving nodes NX and NX+1. Here, the polarity transition period refers to a transition period during which the source driving signal VSX converts from a first level to a second level, and the source driving signal VSX+1 concurrently converts from the second level to the first, or vice versa. Specifically, during the charge recycling operation, the charge recycling device 210(X, X+1) recycles charges stored in the load capacitor CLX-CLX+1 to the internal storage capacitors. During the charge reutilization operation, the charge recycling device 210(X, X+1) redistributes the charges recycled by the storage capacitors to the load capacitor CLX-CLX+1. The charge recycling devices 210(1, 2)-210(M−1, M) and the source driver 200 may be integrated into a single integrated circuit (IC) chip, or can be independent circuits.

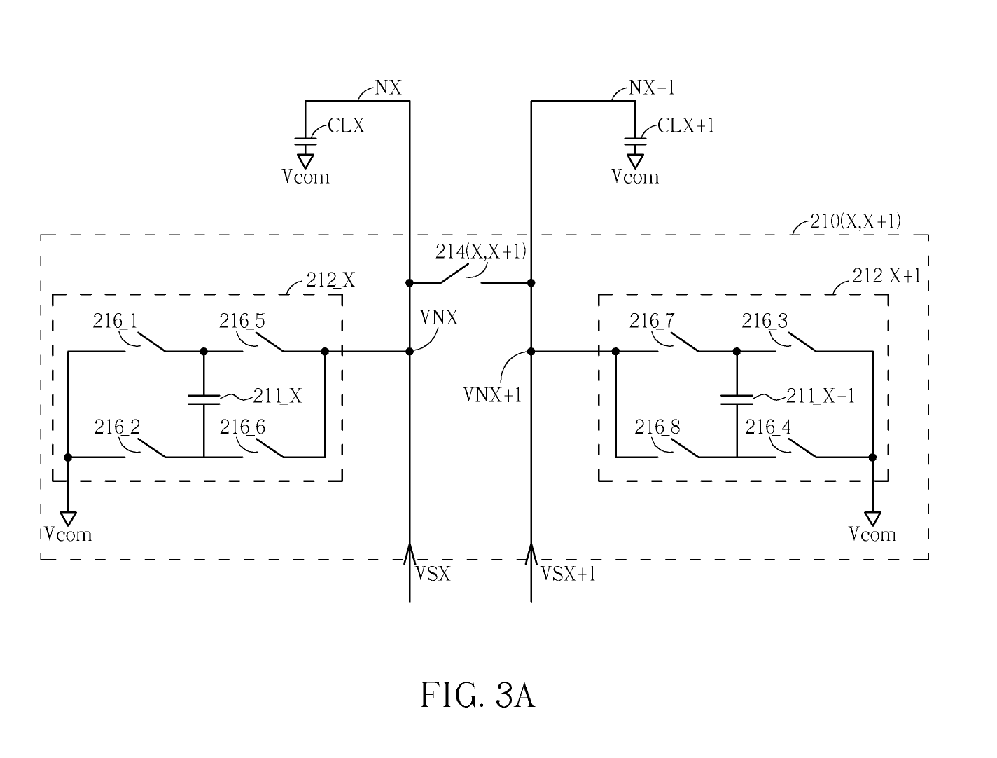

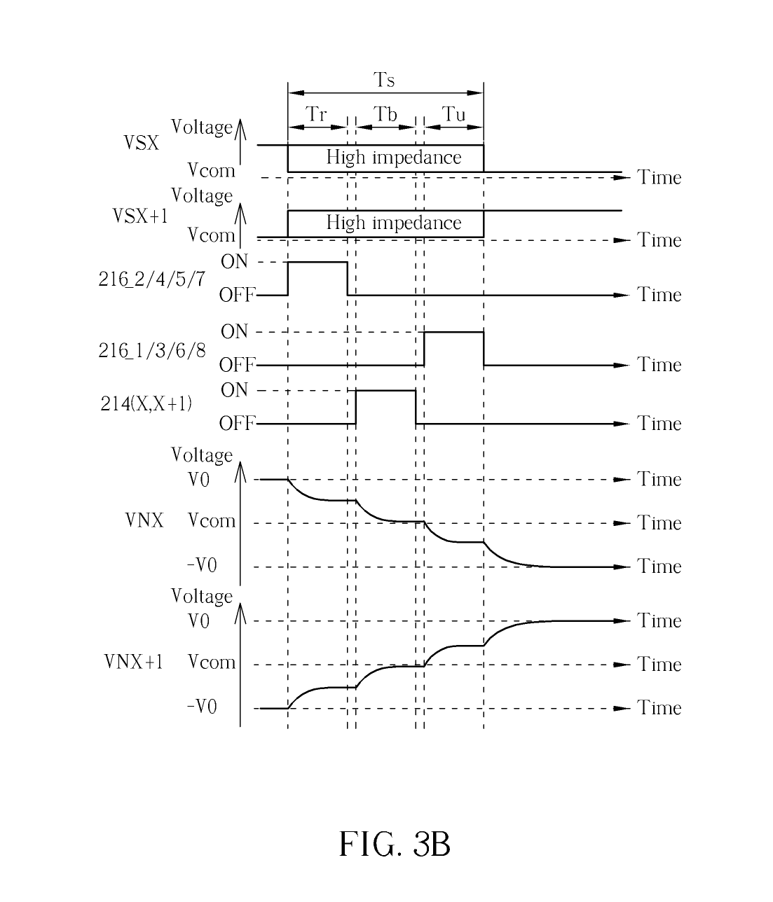

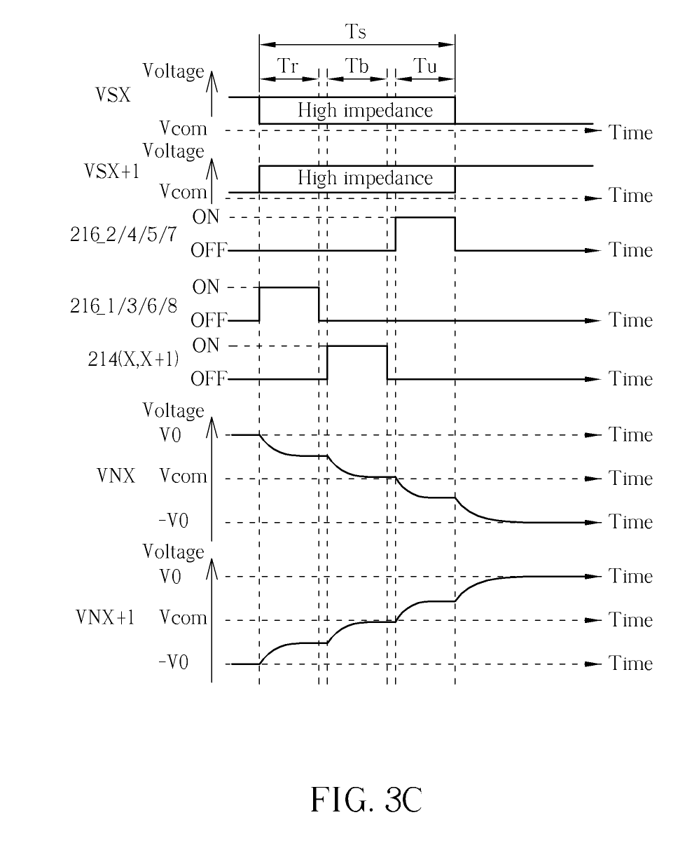

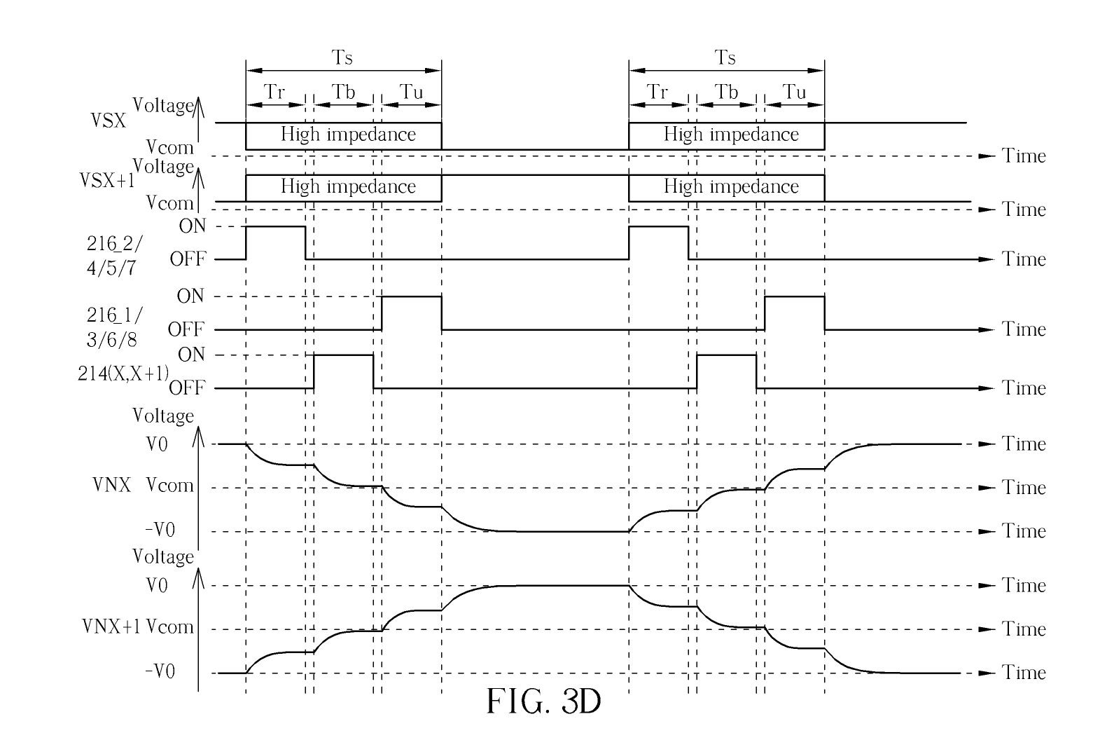

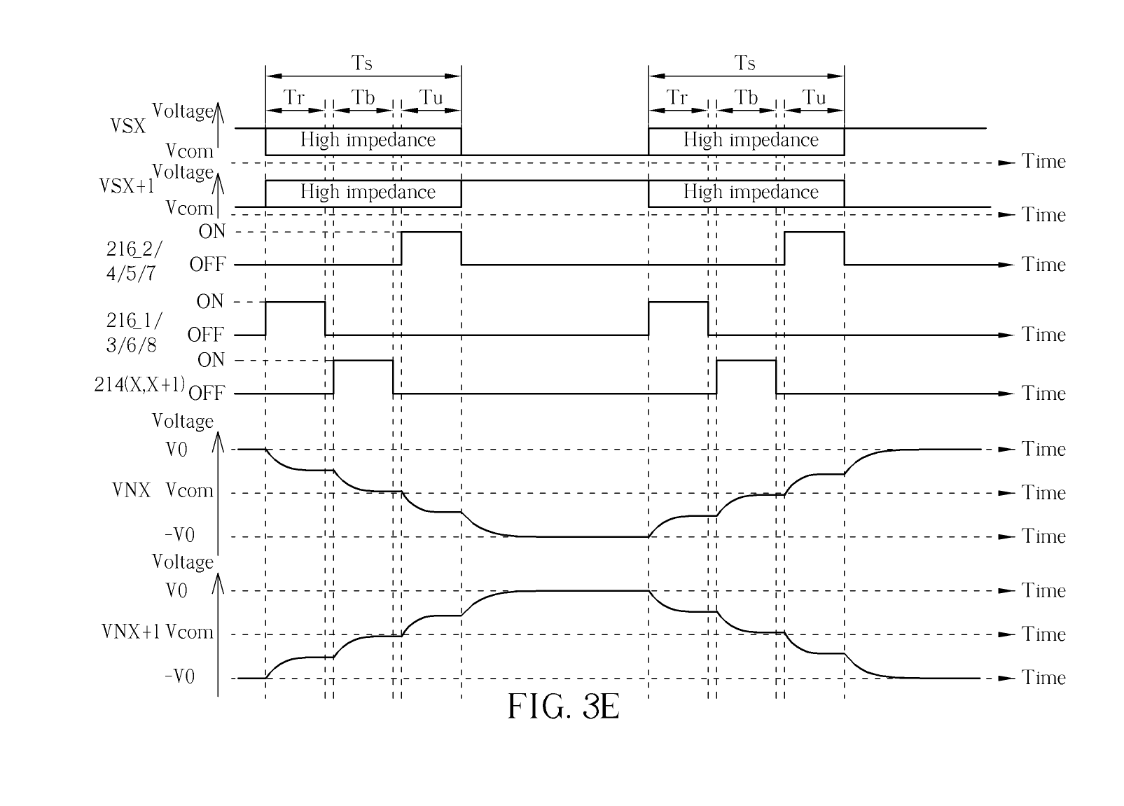

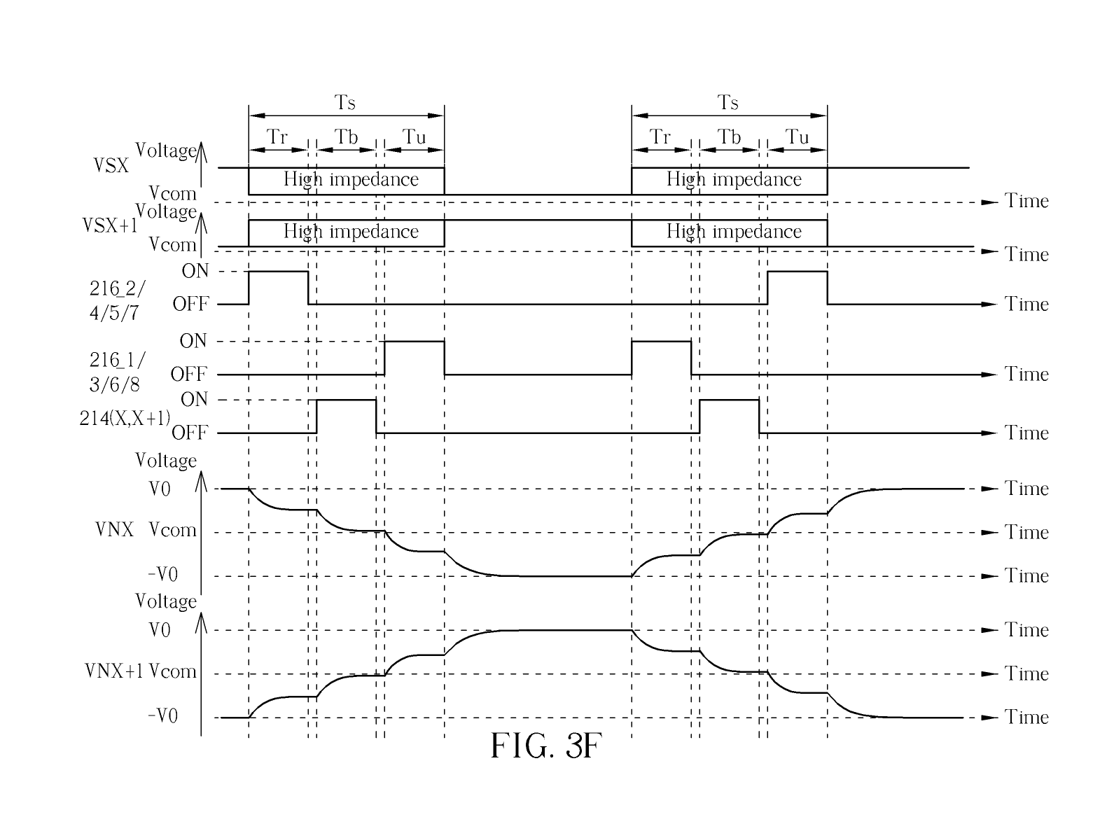

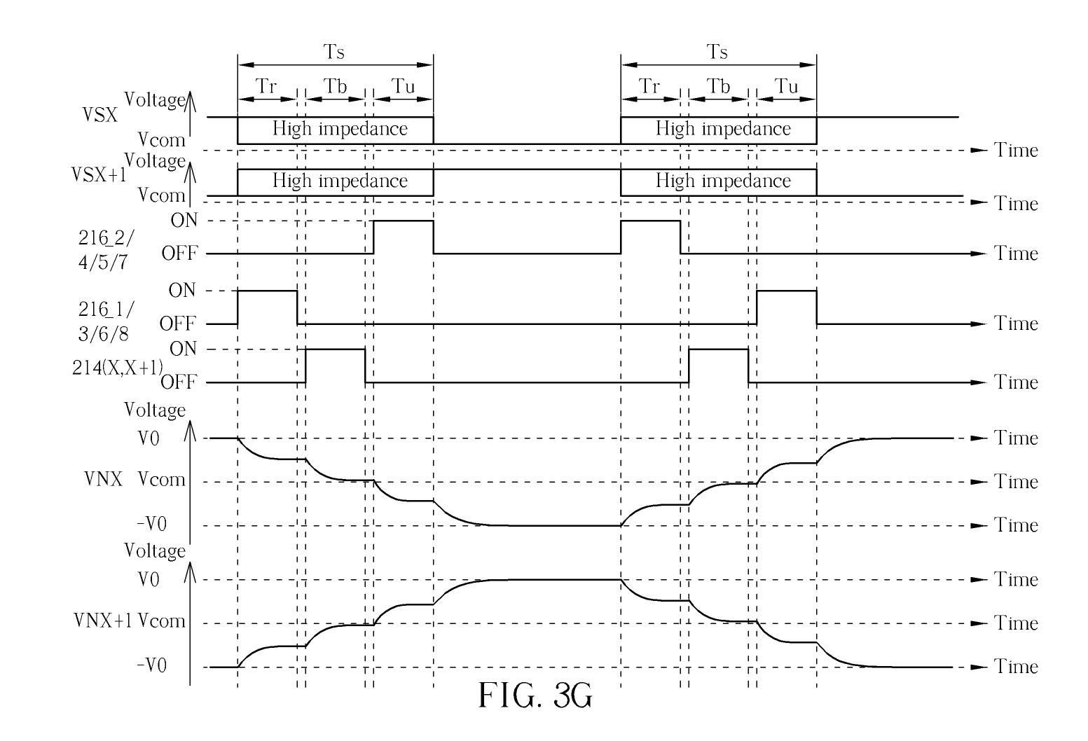

Please refer to FIG. 3A, which is a schematic diagram of a detailed structure of the charge recycling device 210(X, X+1) according to an embodiment. As shown in FIG. 3A, the charge recycling device 210(X, X+1) includes a first storage capacitor 211_X, a second storage capacitor 211_X+1, a first switch module 212_X, a second switch module 212_X+1 and a balancing switches 214(X, X+1). The first switch module 212_X controls a flow of charge between the first load capacitor CLX and the first storage capacitor 211_X, and the second switch module 212_X+1 controls a flow of charge between the second load capacitor CLX+1 and second storage capacitor 211_X+1.

As an example, the first and second switch modules 212_X, 212_X+1 may each include a first set of switches and a second set of switches. The first set of switches of the first switch module 212_X (e.g. including switches 216_2 and 216_5) are coupled between a reference voltage Vcom and the first storage capacitor 211_X. Similarly, the first set of switches of the second switch module 212_X+1 (e.g. including switches 216_4 and 216_7) are coupled between the reference voltage Vcom and the second storage capacitor 211_X+1. Furthermore, the second set of switches of the first switch module 212+X, (e.g. including switches 216_1 and 216_6) are coupled between the first source driving node NX and the first storage capacitor 211_X; and the second set of switches of the second switch module 212+X+1, (e.g. including switches 216_3 and 216_8) are coupled between the second source driving node NX+1 and the second storage capacitor 211_X+1.

Please refer to FIG. 3B for detailed operations of the charge recycling device 210(X, X+1) shown in FIG. 3A. FIG. 3B is a timing diagram of the source driving signals VSX, VSX+1, the switches 216_1-216_8, 214(X, X+1), and the node voltages VNX, VNX+1 during a polarity transition period Ts according to an embodiment. During the polarity transition period Ts, the source driver 200 preferably configures the source driving signal to be in a high-impedance state, such that charge may be independently distributed to the load capacitor CLX, CLX+1 and the storage capacitors 211_X, 211_X+1. At a start of the charge recycling and reutilization operations, the node voltages VNX, VNX+1 have opposite initial voltage polarities, namely, levels of the source driving signals VSX, VSX+1 at a positive voltage V0 and a negative voltage −V0 before being cut off, respectively.

Next, charge recycling and reutilization operations can be sequentially performed. Firstly, during a charge recycling period Tr, the first switch module 212_X can enable the first storage capacitor 211_X and the load capacitor CLX to be coupled in parallel in a same direction (hereinafter, “forward parallel coupling”), and the second switch module 212_X+1 can also enable the second storage capacitor 211_X+1 and the load capacitor CLX+1 to be coupled in forward parallel. More specifically, during the charge recycling period Tr, the first switch module 212_X or the second switch module 212X+1 can enable one terminal of the corresponding first or second storage capacitors 211_X or 211_X+1 to be coupled to the reference voltage Vcom, and the other terminal to be coupled to the corresponding source driving nodes NX or NX+1. In this way, the charge in the corresponding load capacitor CLX or CLX+1 may be recycled to the storage capacitors 211_X or 211_X+1. As such, via charge redistribution, the node voltage VNX can decrease from the positive voltage V0 in a direction towards the reference voltage Vcom provided by the common driver 130, and the node voltage VNX+1 can increase from the negative voltage −V0 in a direction towards the reference voltage Vcom. Next, during a charge balancing period Tb, all of the switches 216_1-216_8 can be cut off, leaving only the balancing switches 214(X, X+1) conducting, such that the node voltages VNX, VNX+1 are balanced substantially at the reference voltage Vcom. Finally, during a charge reutilization period Tu, the first switch module 212_X can enable the first storage capacitor 211_X and the load capacitor CLX to be coupled in reverse parallel, and the second switch module 212_X+1 can also enable the second storage capacitor 211_X and the load capacitor CLX to be coupled in reverse parallel. More specifically, during the charge reutilization period Tu, the switch modules 212_X or 212_X+1 can enable the first terminal of the corresponding storage capacitors 211_X or 212_X to be coupled to the corresponding source driving nodes NX and NX+1 instead, and the second terminal of the storage capacitors 211_X or 212_X to be coupled to the reference voltage Vcom. As a result, the charge recycled by the storage capacitors 211_X or 212_X may be redistributed to the load capacitors CL_X or CL_X+1. Therefore, the node voltage VNX decreases from the reference voltage Vcom towards the negative voltage −V0, and the node voltage VNX+1 increases from the reference voltage Vcom towards the voltage V0. As such, after the polarity transition period Ts, the source driver 200 is capable of driving the node voltages VNX, VNX+1 to target levels of the source driving signals VSX, VSX+1 after inversion while consuming minimal power.

In another embodiment, as shown in FIG. 3C, the first and second switch modules 212_X, 212_X+1 may also first couple the storage capacitors and load capacitors in reverse parallel during the charge recycling period Tr, and then couple the storage and load capacitors in forward parallel during the charge reutilization period Tu. Due to circuit symmetry of the charge recycling devices 210(X, X+1) circuit and the cyclical alternating polarities of the source driving signals VSX, VSX+1, the same charge distribution effect may be achieved. Furthermore, a switching order shown in FIGS. 3B and 3C may still apply if the node voltage VNX is initially at the negative polarity, and the node voltage VNX+1 is initially at the positive polarity. Therefore, with two inversion operations as an example, the switch order shown in FIG. 3B or 3C may be subject to different combinations and permutations to achieve inversion operations shown in FIGS. 3D to 3G. Detailed operations are well known to those skilled in the art, and are not further described here.

In summary, during the polarity transition period where polarities of the pair of source driving signals can be alternatively inverted based on dot inversion, the following operations can be sequentially performed. First, when the two source driving signals move towards the reference voltage Vcom, charges from the positive/negative terminals of a load capacitor can be recycled to the storage capacitors. Next, after the source driving signals cross the reference voltage Vcom and switch polarities, the negative/positive charges can be fed back to the load capacitor, so as to generate in advance the source driving signal after inversion. As such, just slight change in the source driving signal of the source driver 200 can achieve the target voltage level, thereby greatly reducing driving power consumption.

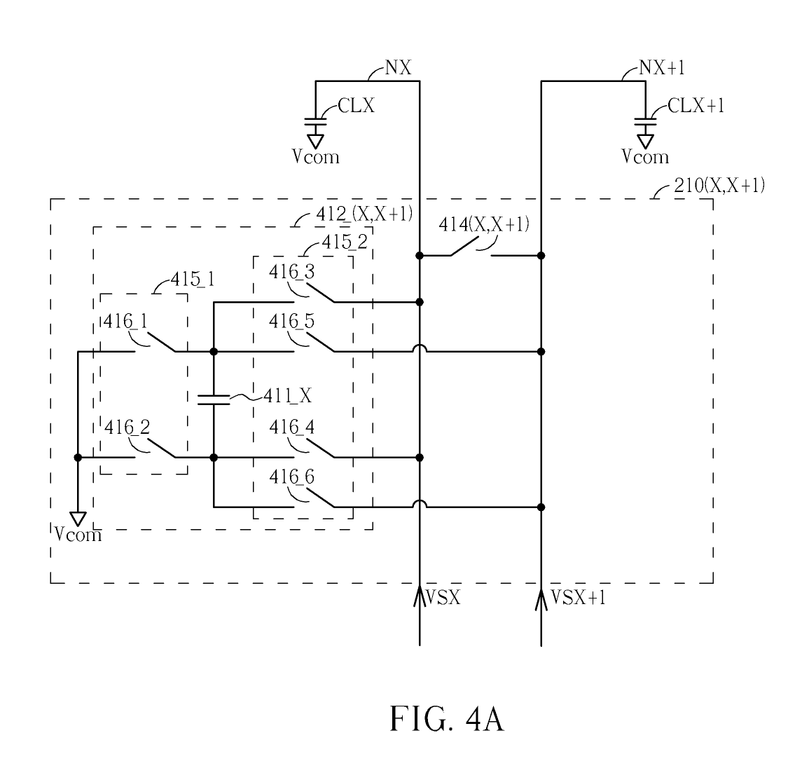

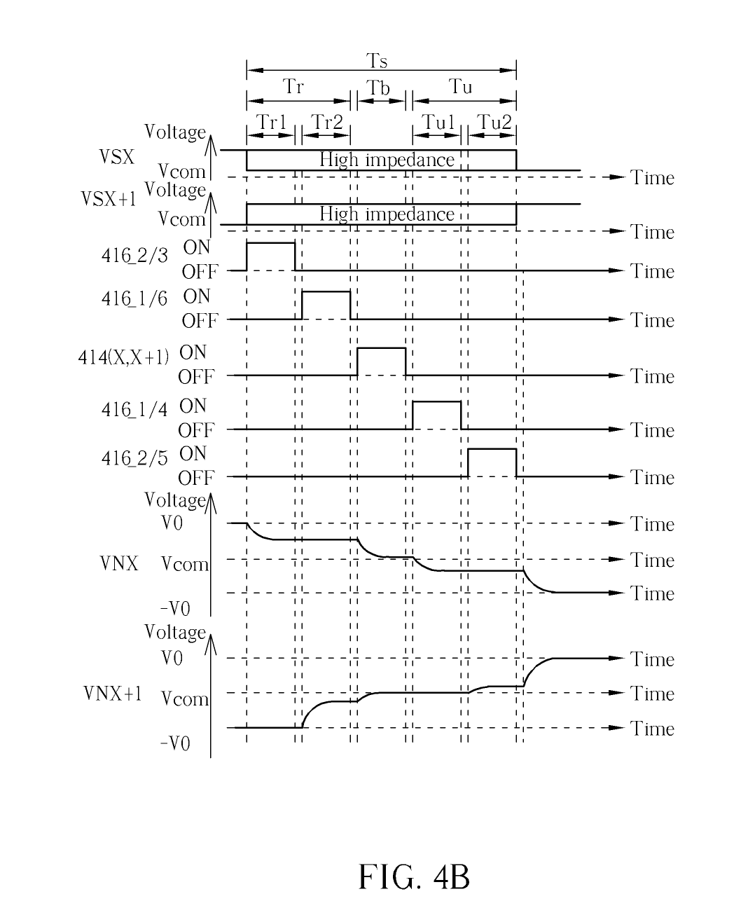

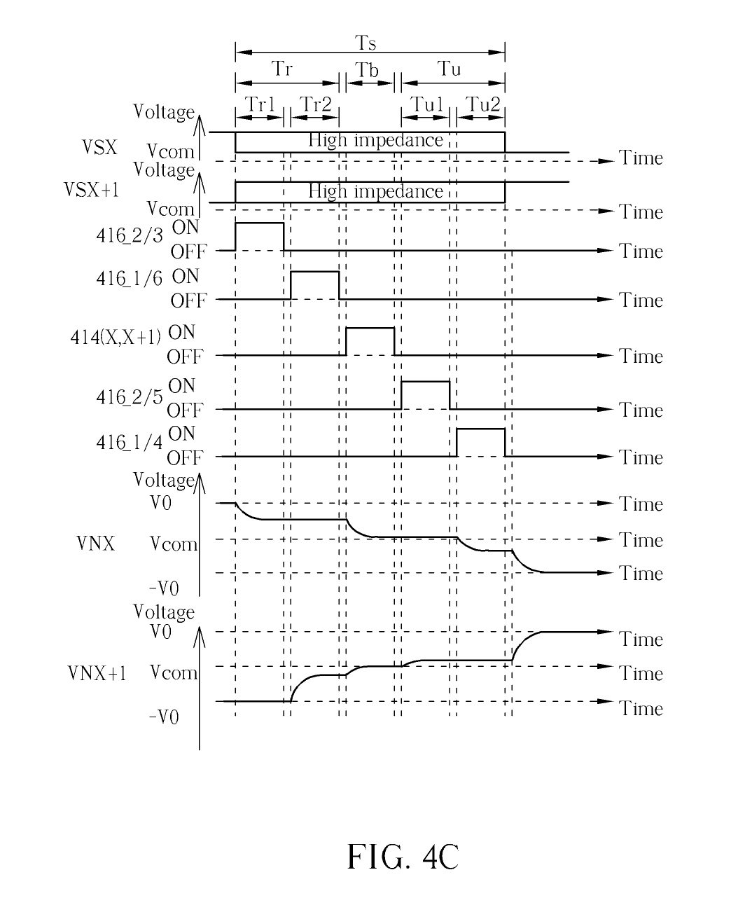

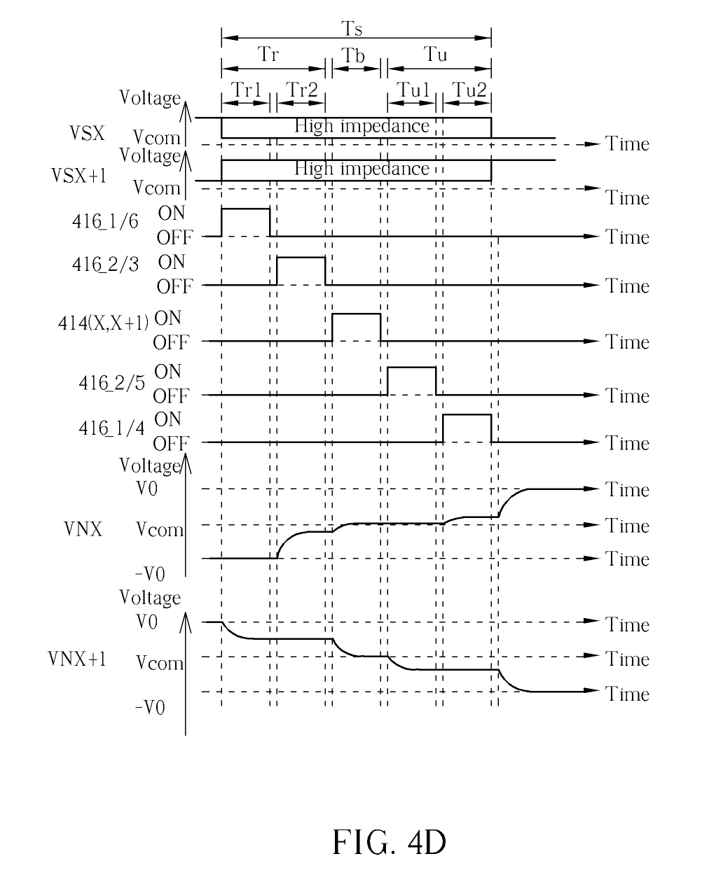

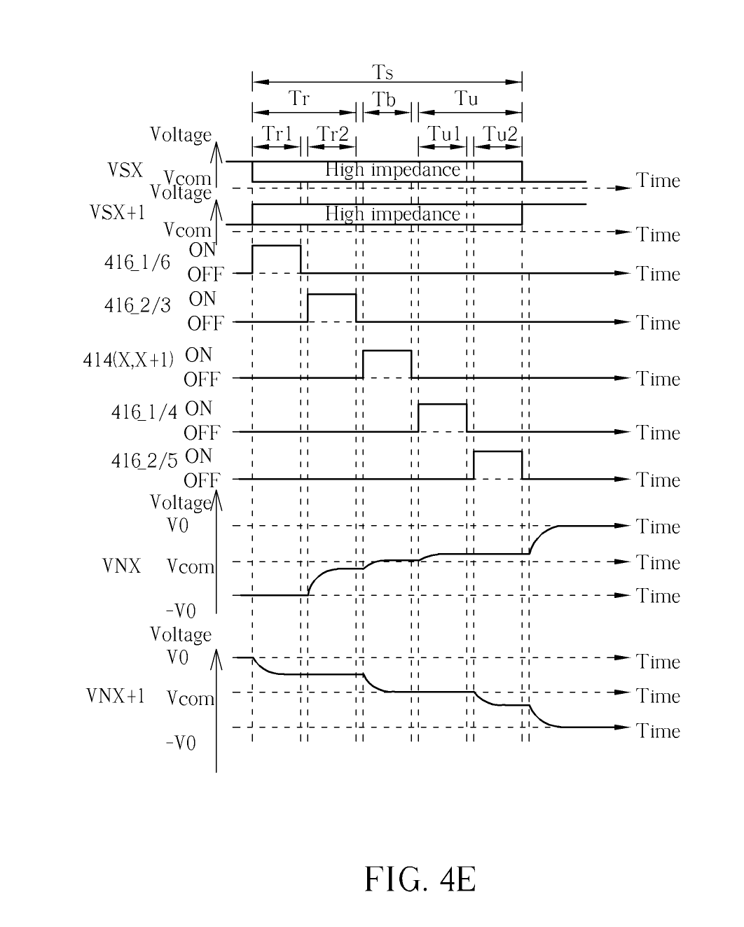

Apart from the embodiment shown in FIG. 3A, FIG. 4A shows another possible detailed structure of the charge recycling device 210(X, X+1) according to another embodiment of the invention. As shown in FIG. 4A, the charge recycling device 210(X, X+1) includes a switch module 412(X, X+1), a balancing switch 414(X, X+1), and a storage capacitor 411_X. The switch module 412(X, X+1) may include a first set of switches 415_1 and a second set of switches 415_2. The first set of switches 415_1 may include switches 416_1, 416_2, coupled between the reference voltage Vcom and the storage capacitor 411_X. The second set of switches 415_2 may include switches 416_3-416_6, coupled between the first and second source driving nodes NX and NX+1 and the storage capacitor 411_X.

Please refer to FIG. 4B for operations of the charge recycling device 210(X, X+1) shown in FIG. 4A. FIG. 4B is a timing diagram of the source driving signals VSX, VSX+1, the switches 416_1-416_{—6}, 414(X, X+1), and the node voltages VNX, VNX+1 during the polarity transition period Ts according to an embodiment. During a first stage Tr1 of the charge recycling period Tr of the polarity transition period Ts, the switches 416_2, 416_3 are conducted, and the other switches are cut off, to recycle the positive charges of the load capacitor CLX to the storage capacitor 411_X. During a second stage Tr2 of the charge recycling period Tr, the switches 416_1, 416_6 are conducted, and the other switches are off, to recycle negative charges in the load capacitor CLX+1. More specifically, during the first stage Tr1 of the charge recycling period Tr, the switch module 412(X, X+1) couples a first terminal of the storage capacitor 411_X to the reference voltage Vcom, and a second terminal of the storage capacitor 411_X to the source driving node NX. During the second stage Tr2 of the charge recycling period Tr, the switch module 412(X, X+1) changes the first terminal of the storage capacitor 411_X to be coupled to the second source driving node NX+1, and the second terminal of the storage capacitor to the reference voltage Vcom. Similarly, during the charge balancing period Tb, all of the switches 416_1-416_6 are cut off, and only the balancing switch 414(X, X+1) is conducting, to balance the node voltages VNX, VNX+1 to the reference voltage Vcom. Next, during a first stage Tu1 of the charge reutilization period Tu, the switches 416_1, 416_4 are conducted while the remaining switches are cut off, to utilize the charge in the storage capacitor 411_X and to reduce the node voltage VNX. Finally, during a second stage Tu2 of the charge reutilization period Tu, the switches 416_2, 416_5 are conducting while the remaining switches are cut off, to utilize the charges in the storage capacitor 411_X and increase the node voltage VNX+1.

Note that, in another embodiment, as shown in FIG. 4C, it is possible to switch the ordering of the first and second stages Tu1, Tu2 during the charge reutilization period Tu. Furthermore, if the node voltage VNX is initially at the negative polarity, and the node voltage VNX+1 is initially at positive polarity, the ordering of the first and second stages Tr1, Tr2 in the charge recycling period Tr needs to be exchanged, as shown in FIGS. 4D and 4E. Moreover, in an example of two inversion operations, the ordering of the switch operations in FIGS. 4B-4C and FIGS. 4D-4E may be subject to different combinations or permutations, and detailed operations of which are well-known to those skilled in the art and not further described here.

Please compare the charge recycling device 210(X, X+1) and its corresponding operation timing diagrams shown in FIGS. 3A and 4A. Since the charge recycling device 210(X, X+1) shown in FIG. 3 has two switch modules 212_X and 212_X+1, it is capable of concurrently recycling the charge stored in the first and second load capacitors CLX and CLX+1 to the first and second storage capacitors 211_X and 211_X+1 during the charge recycling period Tr, respectively; and it is also capable of concurrently distributing the recycled charge in the first and second storage capacitors 211_X and 211_X+1 to the first and second load capacitors CLX and CLX+1 during the charge reutilization period Tb, respectively. Conversely, the charge recycling device 210(X, X+1) shown in FIG. 4A has only a single switch module 412(X, X+1), and operations need to be split into two stages to sequentially charge/discharge the different load capacitors CLX and CLX+1 during both the charge recycling period Tr and the charge reutilization period Tb. Note that, operations of the charge recycling device 210(X, X+1) shown in FIG. 3 are not limited to that shown in the timing diagram. In another embodiment, the two switch modules 212_X and 212_X+1 may also operate sequentially.

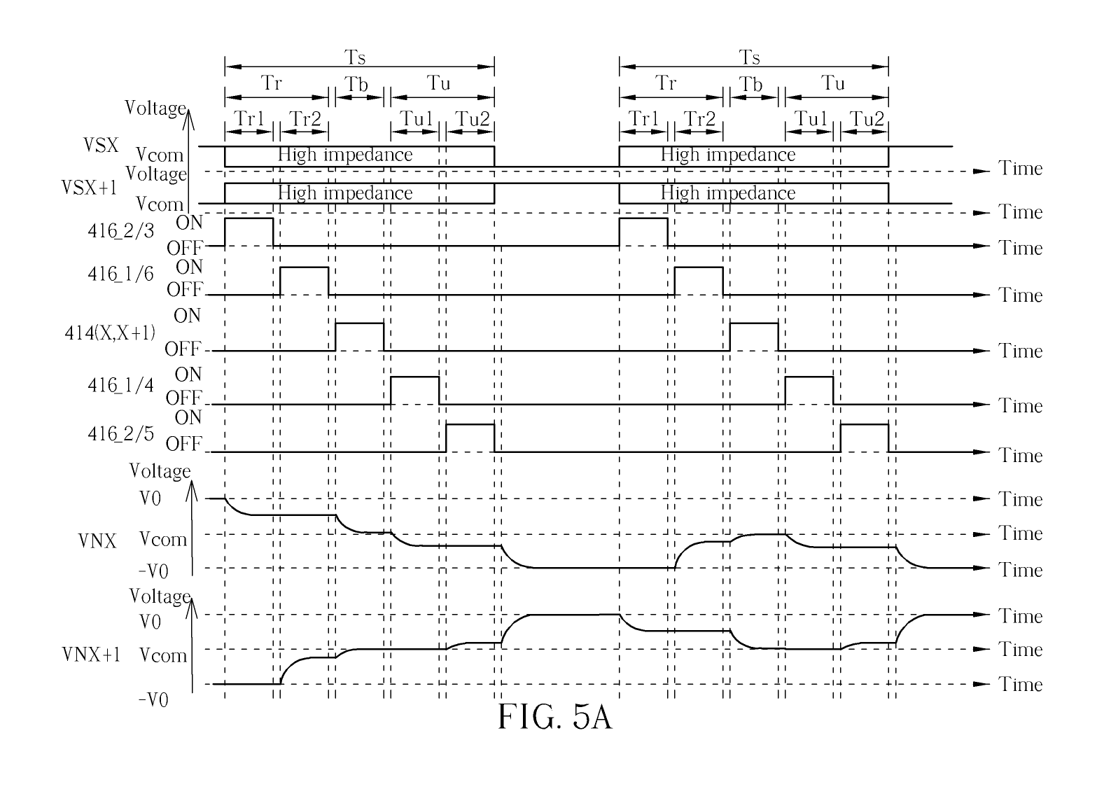

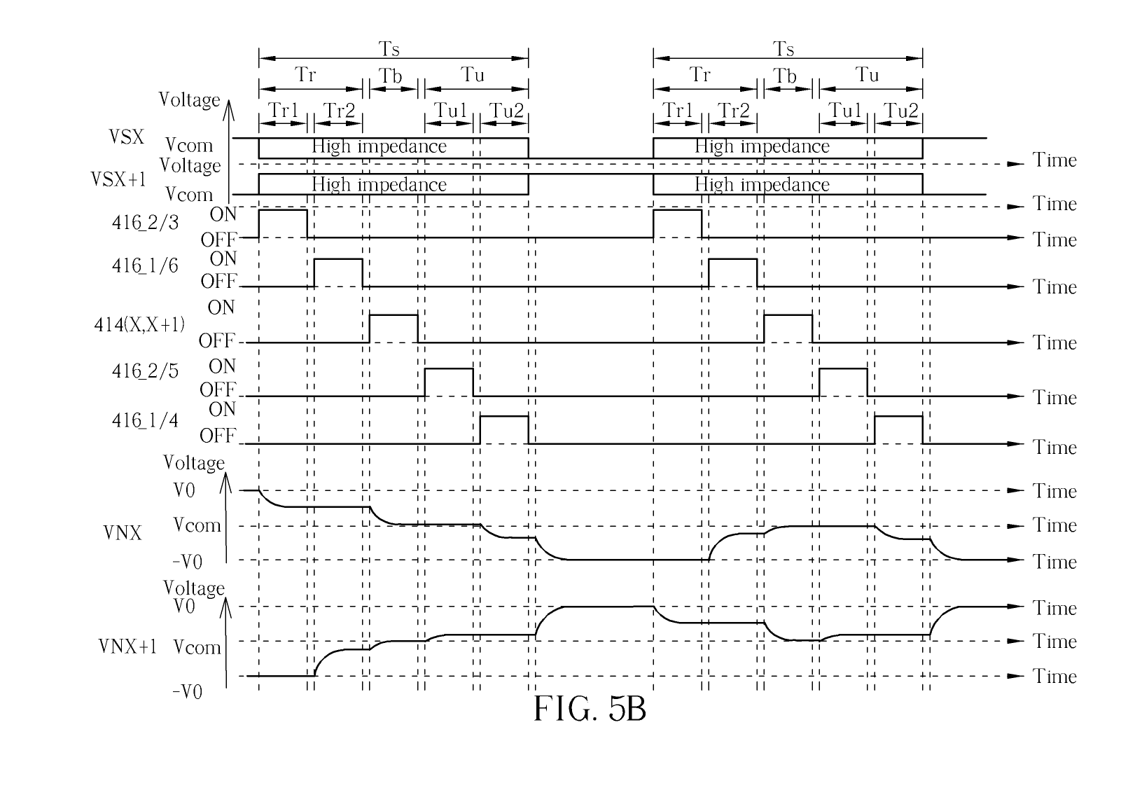

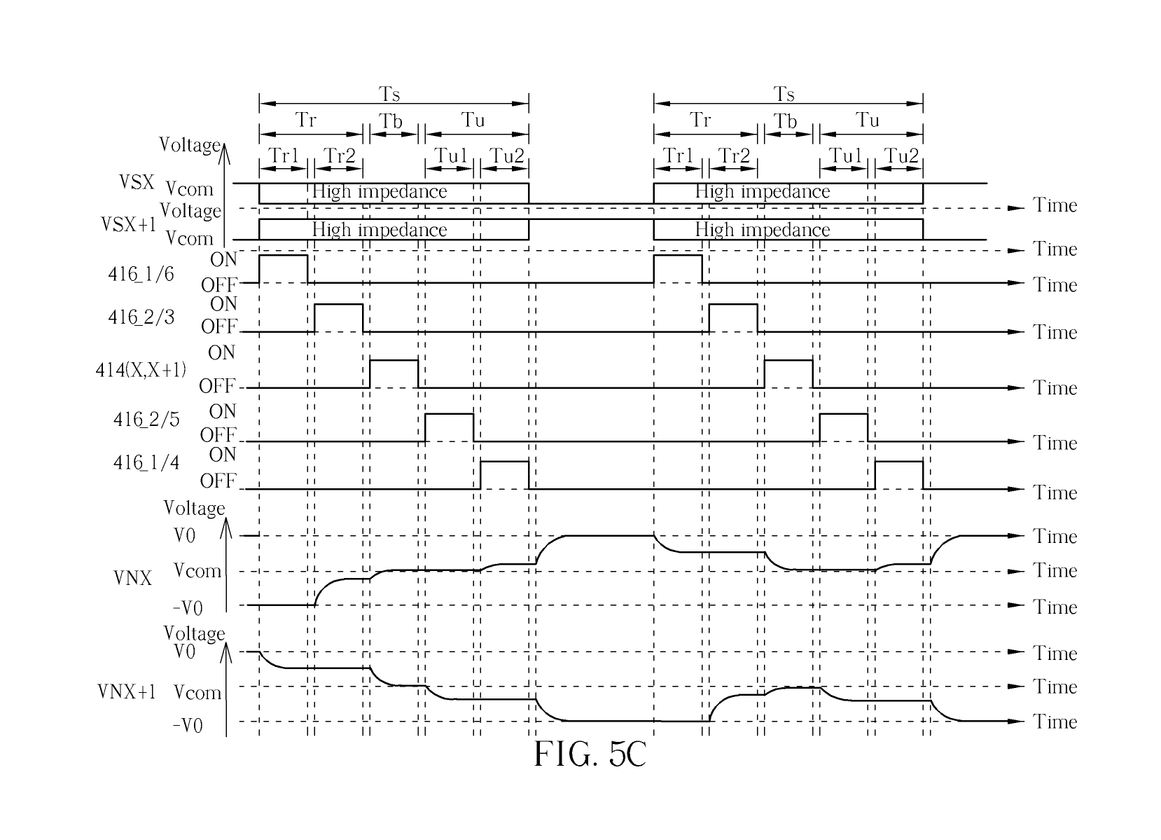

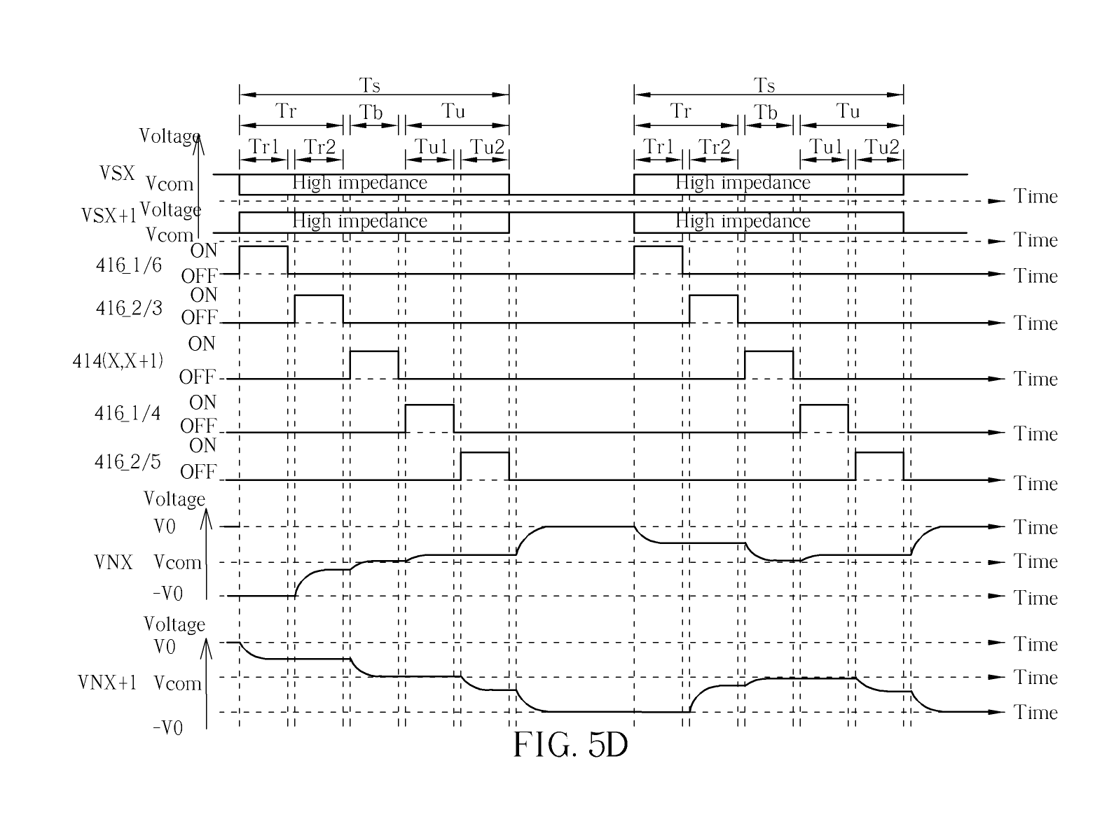

Besides dot inversion driving, the charge recycling device 210(X, X+1) may also be applied to column inversion driving. The difference mainly lies in that the source driving signals VSX, VSX+1 need not switch polarities every time the gate driving signal switches a driving row; instead, polarities may be inverted after the whole screen has been updated. In such a case, please refer to FIGS. 5A-5D (with same switch ordering as shown in FIGS. 4B-4E). In FIGS. 5A-5D, after completing a single polarity inversion operation, the node voltages VNX, VNX+1 repeat the operations during a following polarity transition period Ts2, to achieve column inversion driving. As a result, control of the switches 416_1-416_6, 414(X, X+1) may be simplified.

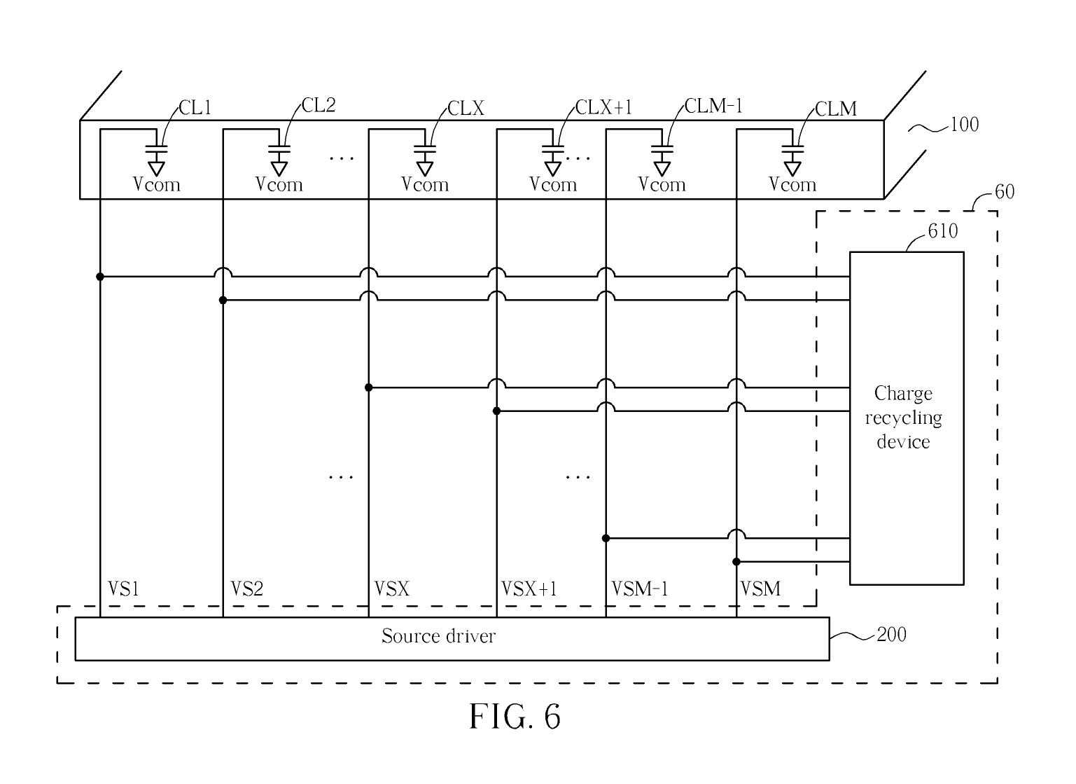

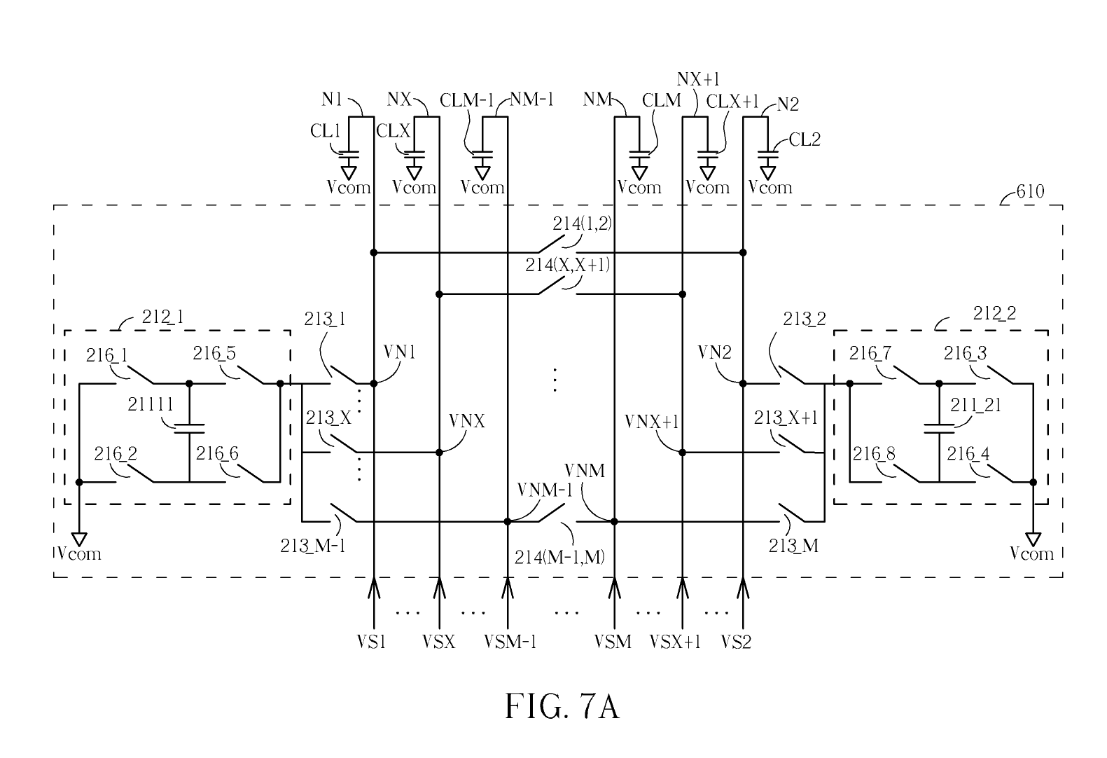

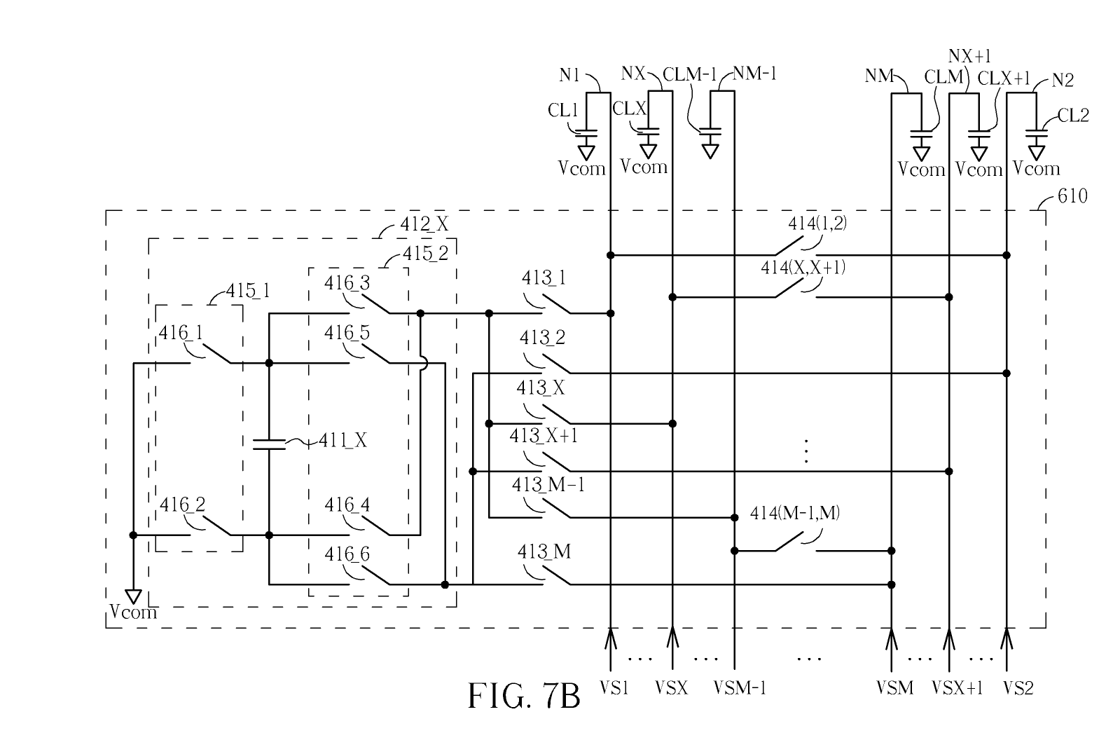

Operations of the above-mentioned panel driving apparatus 20 pertain to the source driving signals VSX, VSX+1 having reverse polarities. In reality, development of LCD driving technology has brought various other inversion techniques. To this end, please refer to FIGS. 6, 7A, and 7B. FIG. 6 shows a different panel driving apparatus 60 of the panel driving apparatus 20 according to another embodiment. A main distinction from the embodiment shown in FIG. 2 is that the panel driving apparatus 60 utilizes a shared charge recycling device 610, and not the multiple charge recycling devices 210(1, 2)-210(M−1, M). Similarly, the charge recycling device 610 and the source driver 200 may be integrated into a same IC chip, or be independent circuits.

FIGS. 7A and 7B are schematic diagrams of the charge recycling device 610 shown in FIG. 6 according to two different embodiments. The charge recycling device 610 shown in FIG. 7A is similar to that shown in FIG. 3A, with a primary distinction that node switches 213_1-213_M are arranged between all of the source driving nodes N1-NM and the switch modules. Similarly, a main difference between the charge recycling device 610 shown in FIG. 7B and that shown in FIG. 4A is that the node switches 413_1-413_M are arranged between all of the source driving nodes N1-NM and switch modules. In this way, the switch modules 212_X, 212_X+1, and 412_X may be concurrently coupled to multiple source driving nodes to implement different inversion operations.

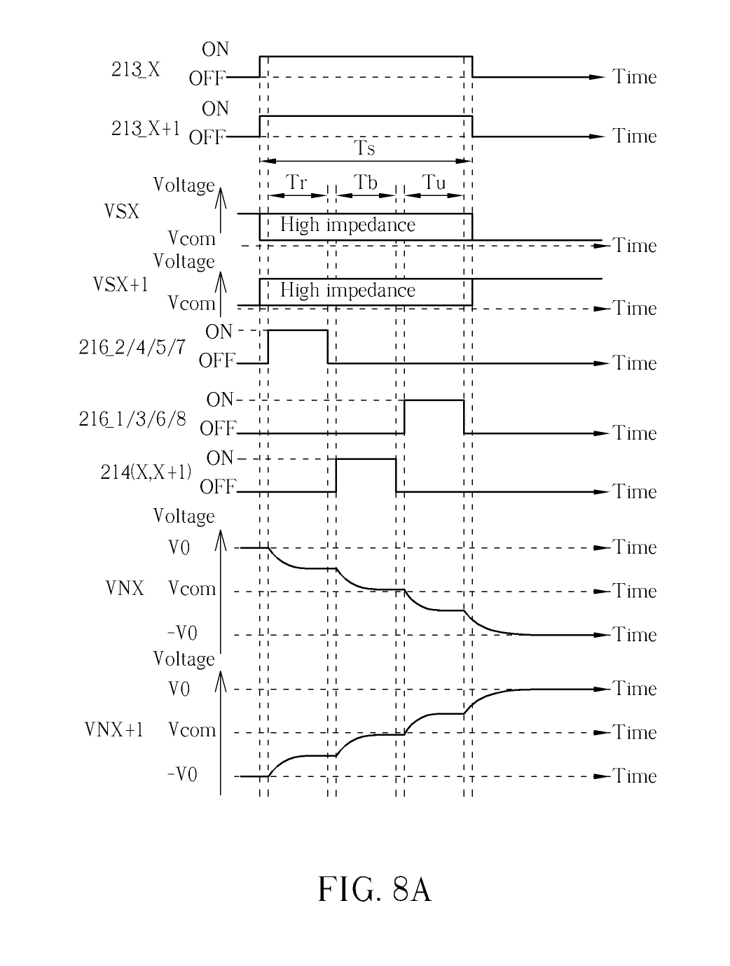

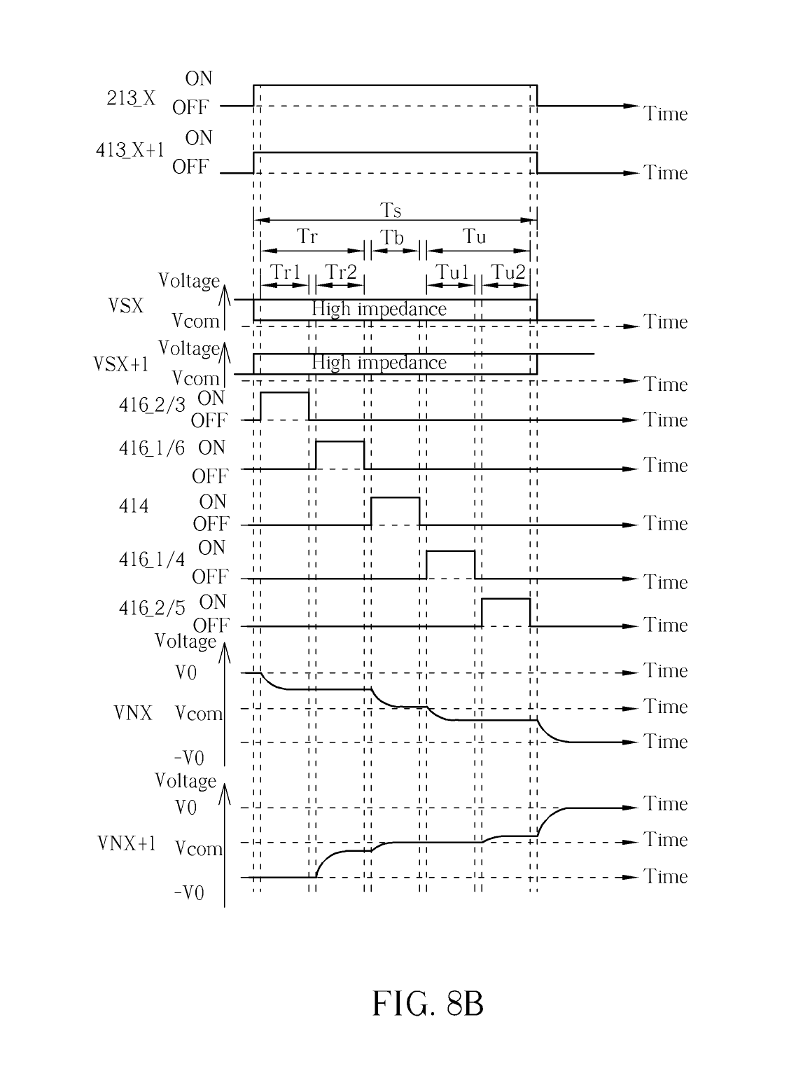

FIGS. 8A and 8B are timing diagrams of operations of the charge recycling device 610 shown in FIGS. 7A and 7B, respectively. FIGS. 8A and 8B are similar to FIGS. 3B and 4B, respectively, with a main difference that the node switches 213_X and 213_X+1 in FIG. 7A and the node switches 413_X and 413_X+1 in FIG. 8A are only conducted during the polarity transition period Ts of the corresponding source driving signals VNX and VNX+1, to control the charge recycling and charge reutilization mechanisms. Other possible switch operations maybe derived from the node switch operations of the driving methods shown in FIGS. 3C-3G and FIGS. 4C-5D, and are not further described here. As such, the node switches 213_1-213_M, 413_1-413_M can provide extra control flexibility to fulfill requirements of various polarity inversion driving methods.

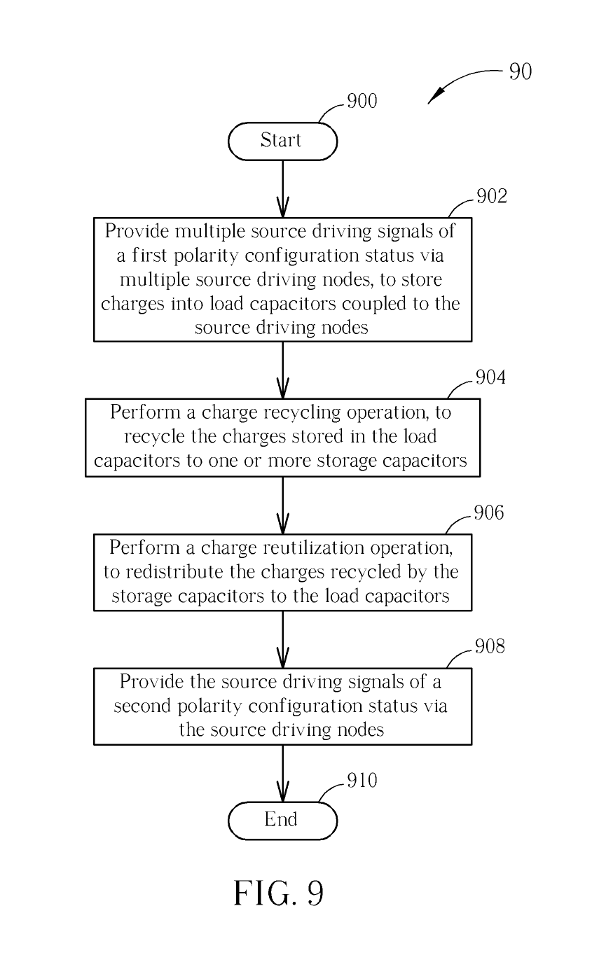

The operations of the panel driving apparatus 20 can be summarized into a driving process 90, as shown in FIG. 9. The driving process 90 includes the following steps:

Step 900: Start.

Step 902: Provide multiple source driving signals of a first polarity configuration status via multiple source driving nodes, to store charges into load capacitors coupled to the source driving nodes.

Step 904: Perform a charge recycling operation, to recycle the charges stored in the load capacitors to one or more storage capacitors.

Step 906: Perform a charge reutilization operation, to redistribute the charges recycled by the storage capacitors to the load capacitors.

Step 908: Provide the source driving signals of a second polarity configuration status via the source driving nodes.

Step 910: End.

Details to the driving process 90 can be found in the aforementioned embodiments pertaining to the charge recycling devices 210(1, 2)-210(M−1, M), or 610, and are not further described here.

In the prior art, to implement dot inversion driving, the source driver 120 must continuously charge/discharge the load capacitors to alternating opposite polarities, which can be highly power-consuming. Extra switch modules can be used to couple load capacitors of adjacent pixels in the horizontal (row) direction between each row-pixel scan cycle, so as to alleviate the source driver 120 by canceling out the positive/negative polarity charges via charge sharing, but effects are limited. Comparatively, the source driver in the embodiments is capable of recycling the charge of the load capacitors via the storage capacitors during the polarity transition period Ts, and reutilizing the charge via switch operations, to change the levels of the source driving nodes in advance. As such, the source driver in the embodiments is capable of driving node voltages of the source driving nodes to the levels specified by the source signals while consuming lower power.

In summary, the embodiments change the node voltages of the source driving nodes towards the target level of the source driving signal in advance via recycling and inverting the charge in the load capacitors, thereby reducing power consumption for the source driver.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A charge recycling device for a panel display apparatus, the charge recycling device comprising:
one or more storage capacitors; and
one or more switch modules, coupled to the one or more storage capacitors, and coupled to a plurality of load capacitors via a plurality of source driving nodes, for controlling currents between the plurality of load capacitors and the one or more storage capacitors;
wherein during a charge recycling period, the one or more switch modules are arranged to recycle charges stored in the plurality of load capacitors to the one or more storage capacitors; and
during a charge reutilization period, the one or more switch modules are arranged to redistribute the recycled charges from the one or more storage capacitors to the plurality of load capacitors.

2. The charge recycling device of claim 1, wherein the charge recycling period and the charge reutilization period sequentially occur during a polarity transition period of a plurality of source driving signals to which the plurality of source driving nodes are coupled.

3. The charge recycling device of claim 2, wherein a charge balancing period further occurs between the charge recycling period and the charge reutilization period, during which voltages of at least two of the plurality of source driving signals are mutually balanced.

4. The charge recycling device of claim 1, wherein one of the one or more switch modules is coupled to one of the one or more storage capacitors, and concurrently coupled to a first source driving node and a second source driving node of the plurality of source driving nodes.

5. The charge recycling device of claim 4, wherein at a start of the charge recycling period, source driving signals to which the first and second source driving nodes are coupled have opposite polarities.

6. The charge recycling device of claim 4, wherein the switch modules comprises:
a first set of switches, coupled between a reference voltage and the storage capacitor; and
a second set of switches, coupled between the first and second source driving nodes and the storage capacitor.

7. The charge recycling device of claim 6, wherein
the first set of switches comprises a first and a second switch, coupled to two terminals of the storage capacitor, respectively, and to the reference voltage; and
the second set of switches comprises:
a third and a fourth switch, coupled to the two terminals of the storage capacitor, respectively, and to the first source driving node; and
a fifth and a sixth switch, coupled to the two terminals of the storage capacitor, respectively, and to the second source driving node.

8. The charge recycling device of claim 7, wherein
during a first stage of the charge recycling period of a polarity transition period, the second and third switches are in a first conducting/cut-off state, the first and sixth switches are in an opposite second conducting/cut-off state, and the fourth and fifth switches are in a cut-off state;
during a second stage of the charge recycling period of the polarity transition period, the second and third switches are switched to the second conducting/cut-off state, the first and sixth switches are switched to the opposite first conducting/cut-off state, and the fourth and fifth switches are in the cut-off state;
during a first stage of the charge reutilization period of the polarity transition period, the first and fourth switches are in a first conducting/cut-off state, the second and fifth switches are in an opposite second conducting/cut-off state, and the third and sixth switches are in the cut-off state; and
during a second stage of the charge reutilization period of the polarity transition period, the first and fourth switches are switched to the second conducting/cut-off state, the second and fifth switches are switched to the opposite first conducting/cut-off state, and the third and sixth switches are in the cut-off state.

9. The charge recycling device of claim 1 further comprising a plurality of node switches, the each node switch coupled between a source driving node of the plurality of source driving nodes and a switch module of the one or more switch modules.

10. The charge recycling device of claim 9, wherein each of the plurality of switches is conducted during the charge recycling period and the charge reutilization period corresponding to the source driving node to which the each switch is coupled.

11. A panel driving apparatus, comprising:
a source driver, for outputting a plurality of source driving signals at a plurality of source driving nodes; and
the charge recycling device of claim 1, coupled to the plurality of source driving signals.

12. A driving method for driving a panel display apparatus, the driving method comprising sequentially performing following steps:
providing a plurality of source driving signals of a first polarity configuration status via a plurality of source driving nodes, to store charges into a plurality of load capacitors to which the plurality of source driving nodes are coupled;
performing a charge recycling operation, for recycling the charges stored in the plurality of load capacitors to one or more storage capacitors;
performing a charge reutilization operation, for redistributing the charges recycled by the one or more storage capacitors to the plurality of load capacitors; and
providing the plurality of source driving signals of a second polarity configuration status via the plurality of source driving nodes.

13. The driving method of claim 12 further comprising performing a charge balancing operation to balance voltages of the plurality of source driving signals between the charge recycling operation and the charge reutilization operation.

14. The driving method of claim 12, wherein the step of the charge recycling operation comprises sequentially recycling the charges stored in a first and second load capacitor of the plurality of load capacitors to a first and second storage capacitor of the one or more storage capacitors at different times, respectively.

15. The driving method of claim 12, wherein the step of the charge reutilization operation comprises sequentially redistributing the charges recycled by a first and second storage capacitor of the one or more storage capacitors charge to a first and second load capacitor of the plurality of load capacitors at different times, respectively.

16. A charge recycling device for a panel display apparatus, the charge recycling device comprising:
a storage capacitor; and
a switch module, coupled to the storage capacitor and a first and second source driving node of a plurality of source driving nodes, wherein the switch module comprises:
a first set of switches, comprising a first and second switch, coupled to two terminals of the storage capacitor, respectively, and to a reference voltage; and
a second set of switches, comprising a third and fourth switch, coupled to the two terminals of the storage capacitor, respectively, and to the first source driving node, and a fifth and sixth switch, coupled to the two terminals of the storage capacitor, respectively, and to the second source driving node.

17. The charge recycling device of claim 16, wherein source driving signals to which the first and second source driving nodes are coupled have opposite polarities at a start of a polarity transition period of the source driving signals.

18. The charge recycling device of claim 16, further comprising a charge balancing switch, coupled between the first and second source driving nodes.

19. The charge recycling device of claim 16, wherein the switch module is further coupled to other nodes of the plurality of source driving nodes, and the charge recycling device further comprises a plurality of node switches, and the each node switch is coupled between one of the plurality of source driving nodes and the switch module.

20. A panel driving apparatus, comprising:
a source driver, having a plurality of source driving nodes, for outputting a plurality of source driving signals; and
the charge recycling device of claim 16, coupled to one of the plurality of source driving nodes.
